(19) United States
(12) Patent Application Publication
(10) Pub. No.: US 2005/0005592 A1
(43) Pub. Date: Jan. 13, 2005

(54) Hollow turbine

(76) Inventor: William Sheridan Fielder, Ojai, CA (US)

Correspondence Address: WILLIAM S. FIELDER, P.O. Box 1221, OJAI, CA, 93024-1221, US

(21) Appl. No.: 10/885,876

(22) Filed: Jul. 6, 2004

Related U.S. Application Data
(60) Provisional application No. 60/485,577, filed on Jul. 7, 2003.
(60) Provisional application No. 60/487,372, filed on Jul. 15, 2003.
(60) Provisional application No. 60/489,254, filed on Jul. 22, 2003.
(60) Provisional application No. 60/494,186, filed on Aug. 11, 2003.

(51) Int. Cl. B01D 57/02; F04D 1/00; F02G 1/00

(52) U.S. Cl. 60/200.1; 415/121.3; 415/1; 204/157.52; 205/628; 204/538; 60/516

(57) ABSTRACT

A versatile turbine suitable for both hydraulic and pneumatic applications. The turbine's blades are affixed to the inner surface of a cylindrical shell which is free to rotate about an outside supporting structure. Rotational energy is transferred from the outer surface of the rotating cylindrical shell, usually by means of a gear; however, there may be applications better suited for a pulley means of transfer. The vacant central axis of rotation can be closed, by incorporating taller blades to achieve a larger surface area, resulting in greater efficiency, or open, by means of shorter blades forming a hole with the distal edges of the blades, to allow for passing fish and or debris to safely exit. The preferred embodiment further includes a means for electricity generation, water purification, and hydrogen production.

### CROSS-REFERENCE TO RELATED APPLICATIONS

This application claims benefit of Provisional Application Ser. No. 60/485,577 filed Jul. 7, 2003; 60/487,372 filed Jul. 15, 2003; 60/489,254 filed Jul. 22, 2003; 60/494,186 filed Aug. 11, 2003 all by the present inventor.

### FEDERALLY SPONSORED RESEARCH

Not Applicable.

### SEQUENCE LISTING OR PROGRAM

Not Applicable.

### BACKGROUND OF THE INVENTION

1. Field of Invention

This invention relates generally to turbines and the production of electricity, hydrogen and purified water.

2. Prior Art

The Hydroelectric Power Plant and Hydroelectric Turbine For Producing Electricity From A Water Current both by Williams are the closest of the prior art found to date. They depict a hydroelectric power plant suitable for applications requiring production of a small amount of electricity. Although there may appear to be similarities between this present invention and the Williams turbines, there are fundamental differences. Most notable among them is the turbine's inner rim, which does not exist in this invention. This inner rim is used to channel water at a faster rate than that flowing over the turbine's blades thereby increasing the efficiency of the Williams turbines. To further increase the efficiency of his turbines Williams suggests increasing the size of the diameter of his turbine. The turbine described here increases efficiency by eliminating the center hole altogether and by incorporating a funnel with ribs. Another limiting factor of the Williams turbines is the synthetic rubber tires pressed against the outer rim to suspend the turbine as well as transfer rotational energy to an adjacent generator. The pressing of any rotary connecting element against another introduces drag and friction. The turbine described here transfers rotational energy by means of an outer gear. The patents describing the Williams turbines, with the exception of the hydroelectric dam, fail to disclose what will prevent these turbines from floating away with the current. His website in fact depicts an attachment means which violates his principle of a hollow center turbine and shows a shaft connected to a plurality of spokes attached to his turbine.

The Plastic Hydraulic Turbine by Levesque and the Bi-Directional Hydroturbine Assembly for Tidal Deployment by Vauthier are both constrained by the design limitations incorporated in each with respect to the amount of energy produced. In both cases the blade's surface areas are constricted by the presence of a central shaft and apparatus. Both are a potential threat to passing fish that may become entangled within the turbine's blades. These turbines are also susceptible to passing debris which may also become entangled within the turbine's blades resulting in damage or even catastrophic failure. The turbine by Levesque is further limited by its most distinctive feature, the plastic used in its construction. The hydro turbine by Vauthier also suffers from the limitations imposed by its flotation device and anchor supports.

The Hydraulic Turbine by Hecker et al. is, by definition, only applicable to hydroelectric power stations, which are typically located along a river. The invention described herein includes support for both river/dam applications as well as ocean current and tidal flow installations. The main limitation of Hecker's turbine is the reduced surface area of the blades resulting from the presence of an axial cone.

Standard turbines such as Francis and Kaplan turbines rely on a central shaft along their axis of rotation to mount their blades and transfer rotational energy. This results in reduced surface area available for energy capture. Also associated with these turbines is certain mortality for a portion the local fish population.

Reduced surface area results in a less efficient turbine.

### OBJECTS AND ADVANTAGES

Accordingly, several objects and advantages of my invention are: to capture or harness the kinetic energy of passing liquids and gases, in an environmentally friendly manner, with an unlimited source of kinetic energy.

Novel features include: a vacant center axis, since energy is captured at the peripheral surfaces instead of from a central shaft; a debris exhaust hole thats size is application dependent; a lightweight and durable turbine made from composite materials; a means for offshore production of hydrogen, distilled water, electricity, and possibly more, located above or below the water line; a scalable design that adjusts to meet energy requirements; a modular design that allows for scalability and maintainability.

### SUMMARY

As with all turbines, the pressure exerted by the impact of a fluid or a gas on the surface of a turbine's blades creates a force perpendicular to the direction of the flow through the turbine. With standard hydraulic turbines, this force is transferred by means of a central shaft residing on the central axis of rotation. Such a structure diminishes the surface area available for energy capture. The invention described here overcomes this limitation by transferring rotational energy from the turbine's outer edge, leaving the central axis open for fish and debris to safely pass through, or closed to achieve greater efficiency through the increased surface area available for kinetic energy capture.

Standard turbines used in river and dam applications have a negative impact on the aquatic life that becomes entangled within the turbine's blades. As previously stated, the opening created by removing the central shaft of a standard turbine would allow for passing fish to exit safely.

Current technologies dedicated to capturing the kinetic energy found in the oceans' currents and tides have significant shortcomings. Chief among these is the use of a central shaft to collect and transfer the kinetic energy captured by the turbine's blades. Additionally, aquatic life and debris can render a standard turbine useless. As previously stated, the opening created by removing the central shaft of a standard turbine would allow for passing fish to exit safely.

The preferred embodiment of the this invention provides facilities for the production of: electricity, purified water, and hydrogen.

### DRAWINGS—FIGURES

FIG. 1 is an intake end view of the cylindrical shell, illustrating the formation of a debris exhaust hole formed by the distal edges of the turbine's blades, with reference to the virtual axis of rotation.

FIG. 2 is an intake end view of the cylindrical shell, illustrating the intersection point of the distal edges of the turbine's blades, with reference to the virtual axis of rotation.

FIG. 3 is a side view of the cylindrical shell, displaying the preferred rotational energy connecting element, a gear, together with an interface for a supporting structure, not shown. Also illustrated are the input of FIG. 1 and exhaust end openings, with reference to the virtual axis of rotation.

FIG. 4 is a repeat of FIG. 3 showing where the cross sectional view of FIG. 5 will be taken.

FIG. 5 is the cross sectional view called out in FIG. 4 and details the optional buoyancy cavities and attached valves. Also shown is the virtual axis of rotation.

FIG. 6 is a repeat of FIG. 1 showing optional buoyancy cavities.

FIG. 7 depicts a side view of a complete hydroelectric installation in an open body of water.

FIG. 8 depicts a side view of a complete hydroelectric installation in a dam.

FIG. 9 details a side view of a complete hydroelectric installation, plus the means for water purification and hydrogen production in a open body of water.

FIG. 10 details a side view of a complete hydroelectric installation, plus the means for water purification and hydrogen production in a dam.

FIG. 11 shows a side view of a funnel connected to the turbine's supporting structure in an open body of water.

FIG. 12 shows a side view of a funnel connected to the turbine's supporting structure within a dam.

FIG. 13 is a frontal view of a funnel with ribs implementation.

FIG. 14 details a side view of an installation, plus the means for exporting hydrogen, purified water and electricity from a support structure in an open body of water. The same means to export electricity may also be used to import electricity.

FIG. 15 details a side view of an installation, plus an access portal for transferring personnel and resources to and from a support structure in an open body of water.

FIG. 16 is a cross sectional view of a turbine blade with an irregular surface.

### DRAWINGS—Reference Numerals

1 Hollow Turbine
2 Cylindrical Shell
3 Inner surface of cylindrical shell
4 Outer surface of cylindrical shell
5 Blade
6 Axis of Rotation
7 Debris Exhaust Hole
8 Input
9 Exhaust
10 Rotational energy connecting element
11 Cavity—Cylindrical Shell
12 Valve
13 Cavity—Blade
14 Support Structure
15 Foundation
16 Bearing
17 Gear
18 Gears
19 Gear support
20 Rotary transmission means
21 Electric generator
22 Water purification means
23 Hydrogen production means
24 Dam
25 Funnel
26 Funnel ribs
27 Hydrogen pipeline
28 Purified water pipeline
29 Electric power pipeline
30 Access portal
31 Floor
32 Hatch
33 Direction of flow

### DETAILED DESCRIPTION—FIGS.

The present invention relates generally to hydraulic turbines, and specifically to increasing the efficiency of present designs and to the new applications now possible.

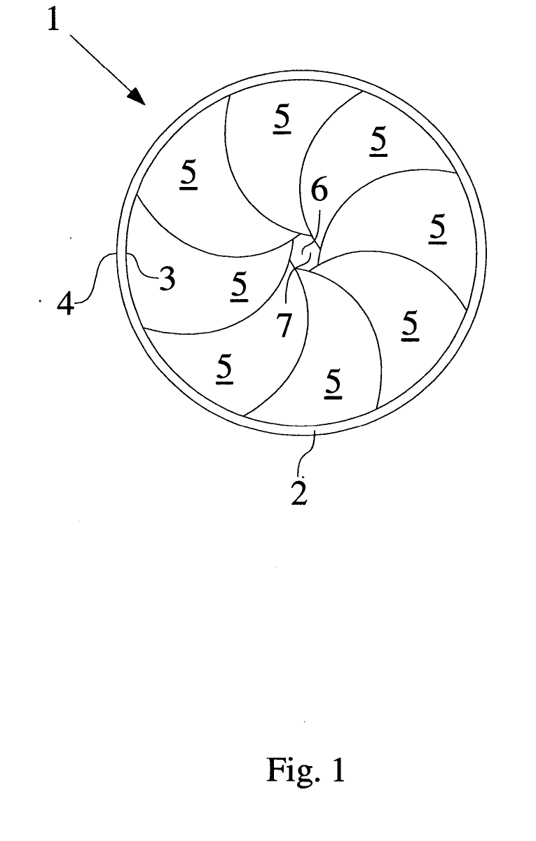

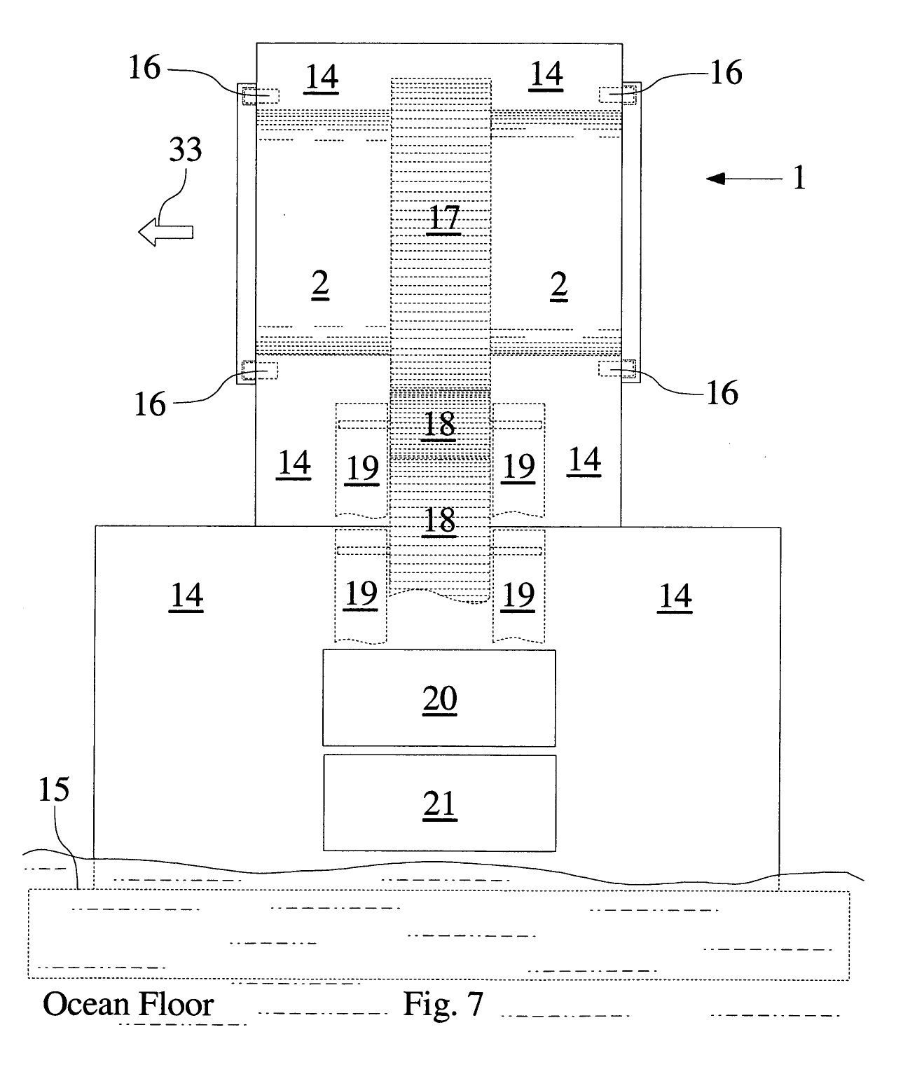

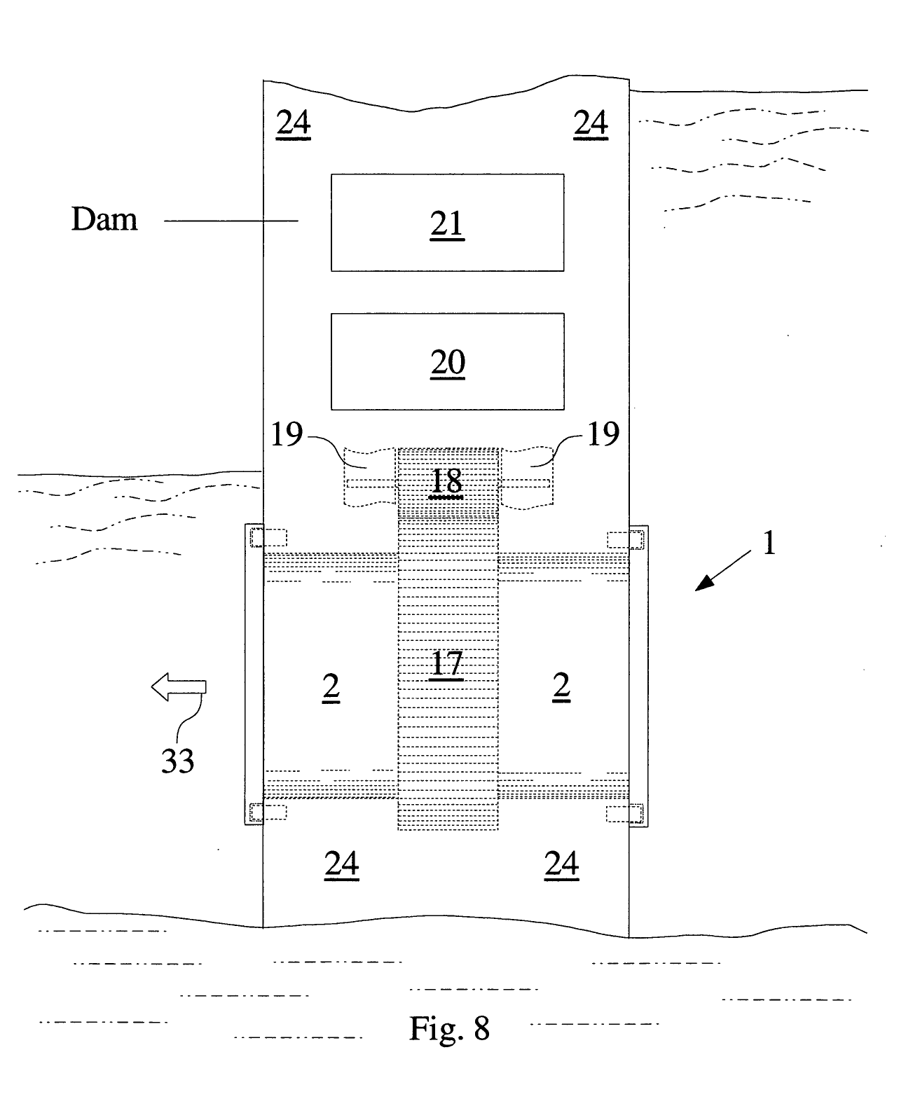

Referring initially to FIG. 1, as with standard turbines, energy is transferred by the pressure of passing gases or liquids against the turbine's 1 blades 5. Blades 5 are attached to the inner surface 3 of a cylindrical shell 2 which is free to rotate within a support structure 14 as referenced in FIG. 7. This arrangement of blades 5 leaves the center axis 6 of the turbine 1 vacant to allow passing fish and debris to safely exit through. The diameter of this debris exhaust hole 7 is dependent on a balance between the need for efficiency and the need to avoid and or preserve passing fish and debris. Blade design may allow for bidirectional support for tidal applications.

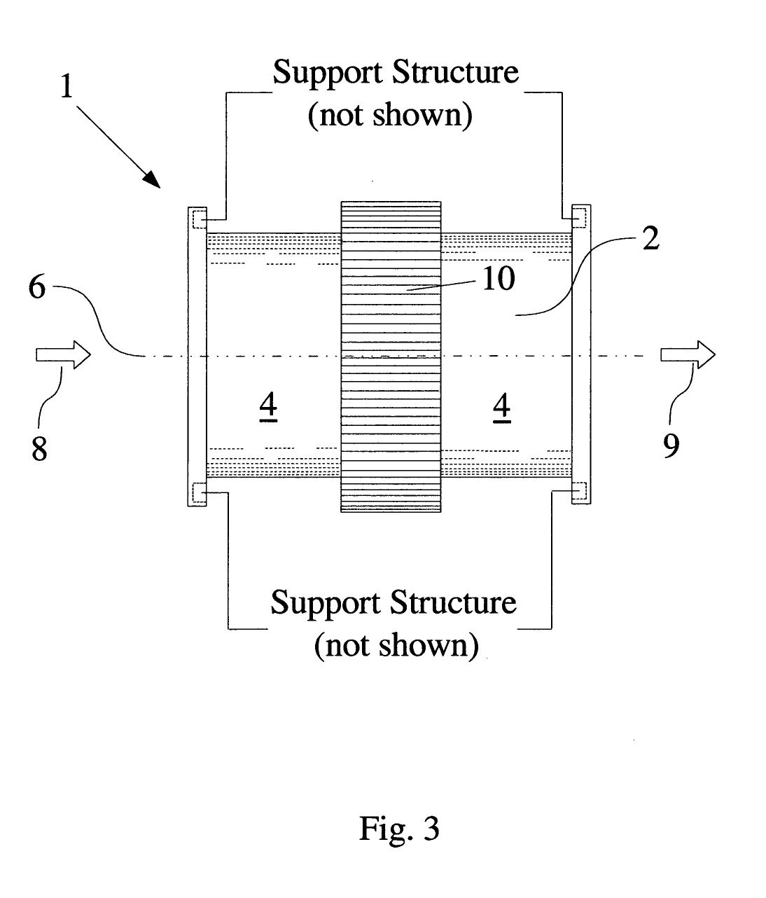

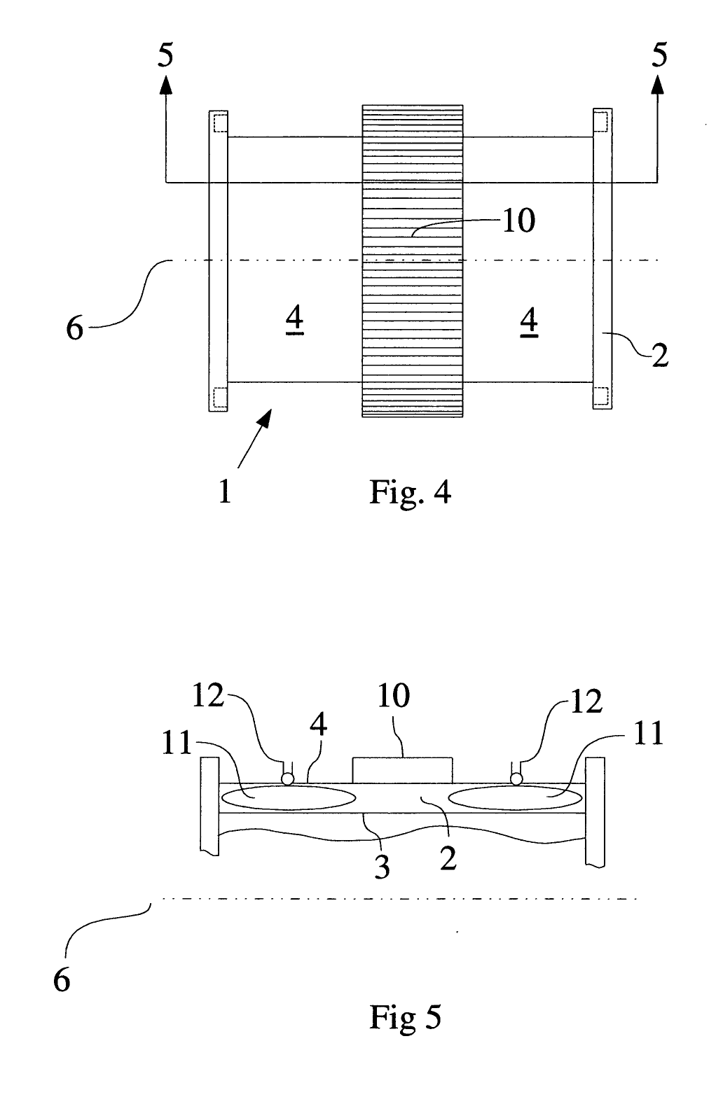

As best shown in FIGS. 3 and 4, attached to the turbine's outer shell 4 is a rotational energy connecting element 10 to transfer the rotational energy produced to its' desired location. This is unlike standard turbine design which transfers energy from a central shaft.

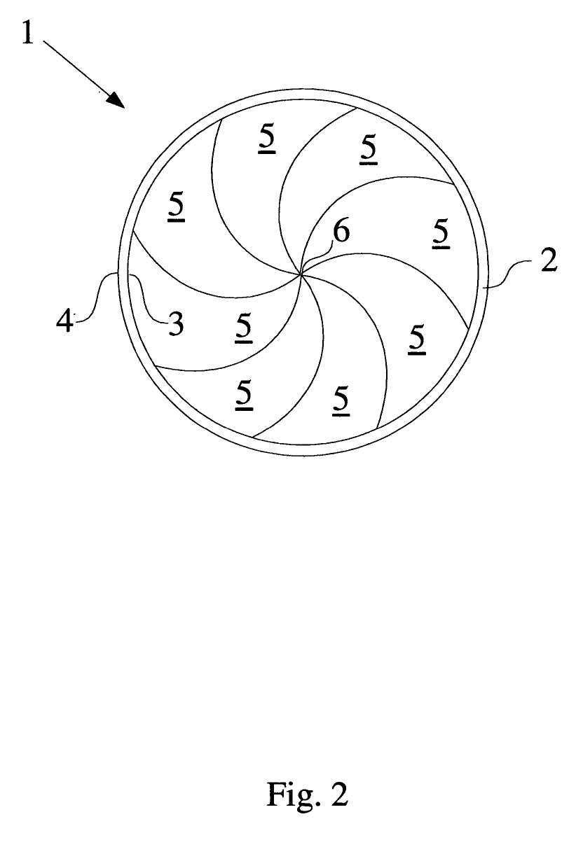

In an alternate embodiment, the distal edges of the turbine's blades 5 are sufficient in size as to form a point at the axis of rotation as illustrated in FIG. 2. This effectively eliminates the debris exhaust hole 6 and achieves maximum efficiency.

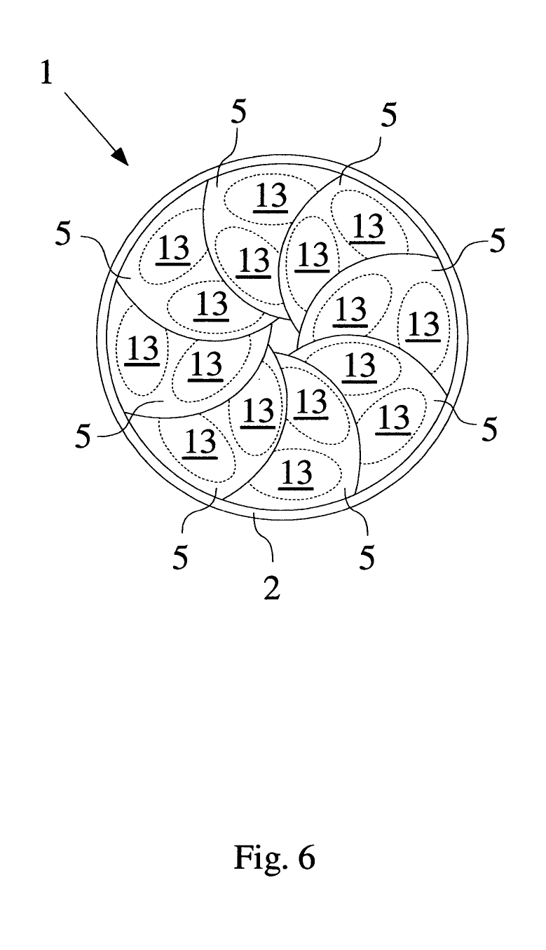

To reduce the weight and drag of the turbine 1, as shown in FIGS. 5 and 6, cavities 11 and 13 are incorporated within the cylindrical shell 2 and turbine blades 5. To achieve a neutral buoyancy valves 12 are used to regulate the amount of air within the cylindrical shell's cavities 11.

Referring to FIG. 7, bearings 16 are used to affix the cylindrical shell 2 to its' supporting structure to allow for the free rotation of the turbine 1. To transfer rotational energy from the turbine's 1 cylindrical shell 2 a variety of gears 18 and supporting elements 19 are incorporated. To engage the rotational connecting element 17 and an electric generator 21 a rotary transmission means 20 is utilized.

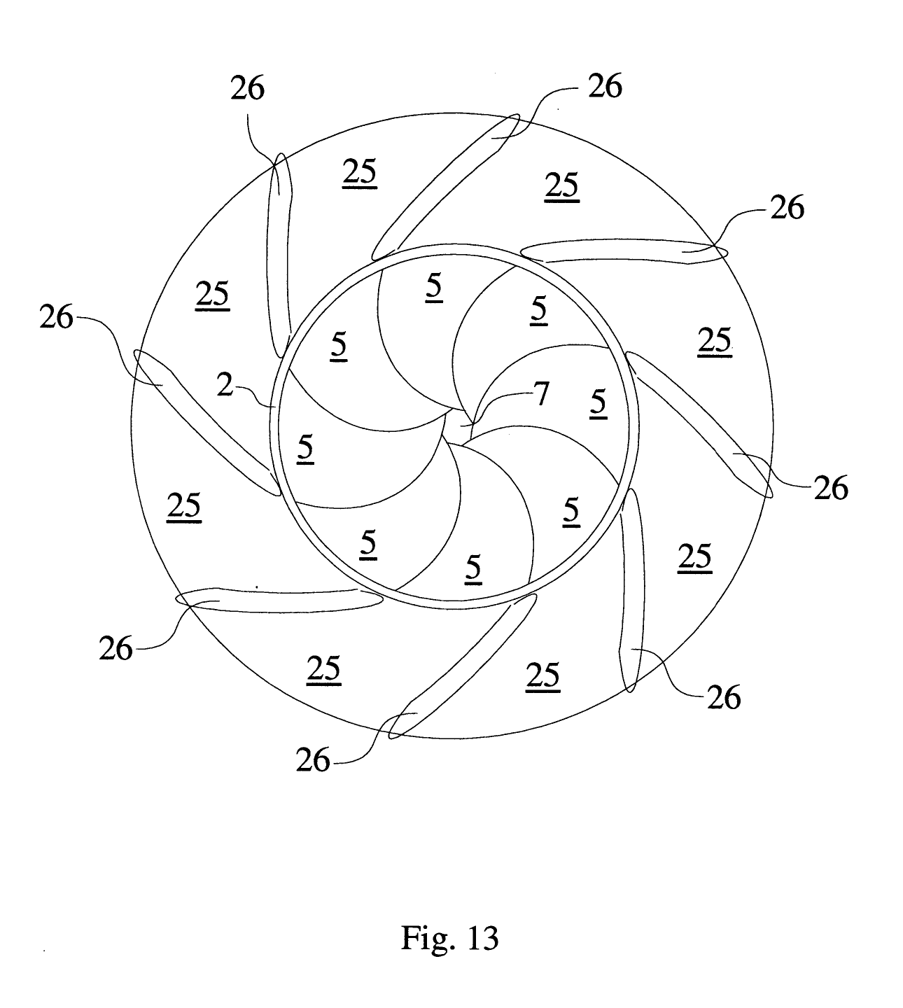

Referring to FIG. 13, in order to increase the pressure on blades 5, when necessary, a funnel structure 25 with ribs 26 is used, to simulate the effect of rifling on a bullet, to direct the ocean current or tide in a direction perpendicular to the turbine's 1 blades 5. A balance between funnel design and the diameter of the debris exhaust hole 7 will result in maximum rotational energy output.

Referring to FIG. 16, in order to increase the efficiency of the turbine's blades 5, an irregular surface on said blades 5 will increase resistance between the turbine's blades 5 and the flow of passing fluids and or gases.

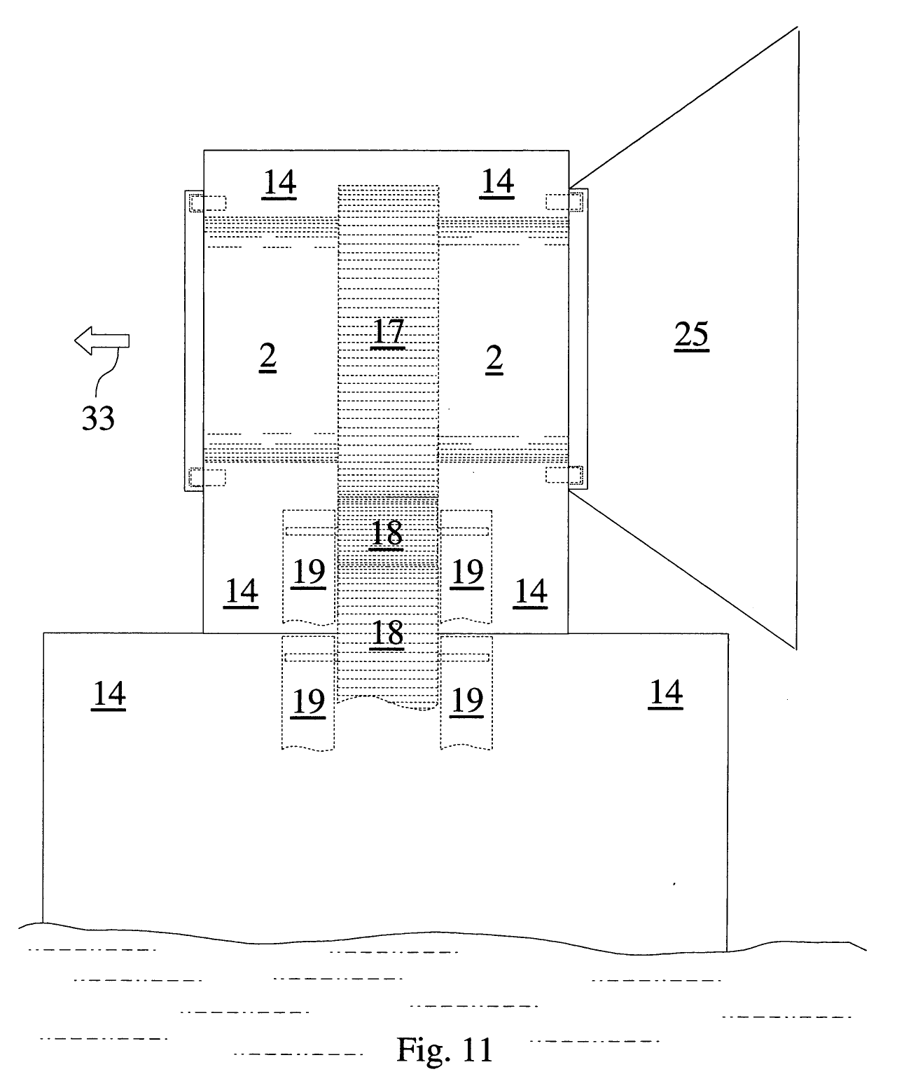

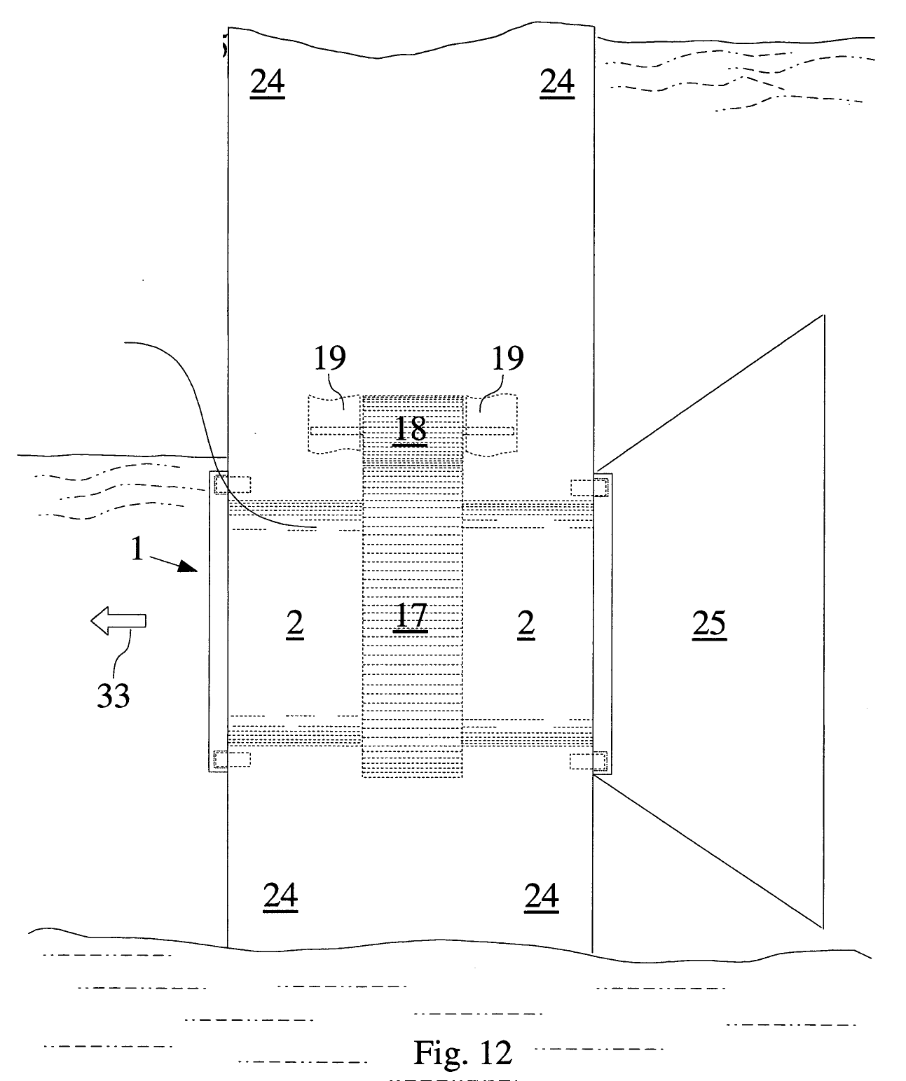

Referring again to FIG. 7, a submersible support structure 14, will suspend the turbine 1 in a fashion allowing for the free movement of said turbine 1. As shown in FIG. 11, the aforementioned funnel structure 25 will attach directly to the outer surface of the turbine's support structure 14. Modifications will allow for bidirectional tidal energy capture.

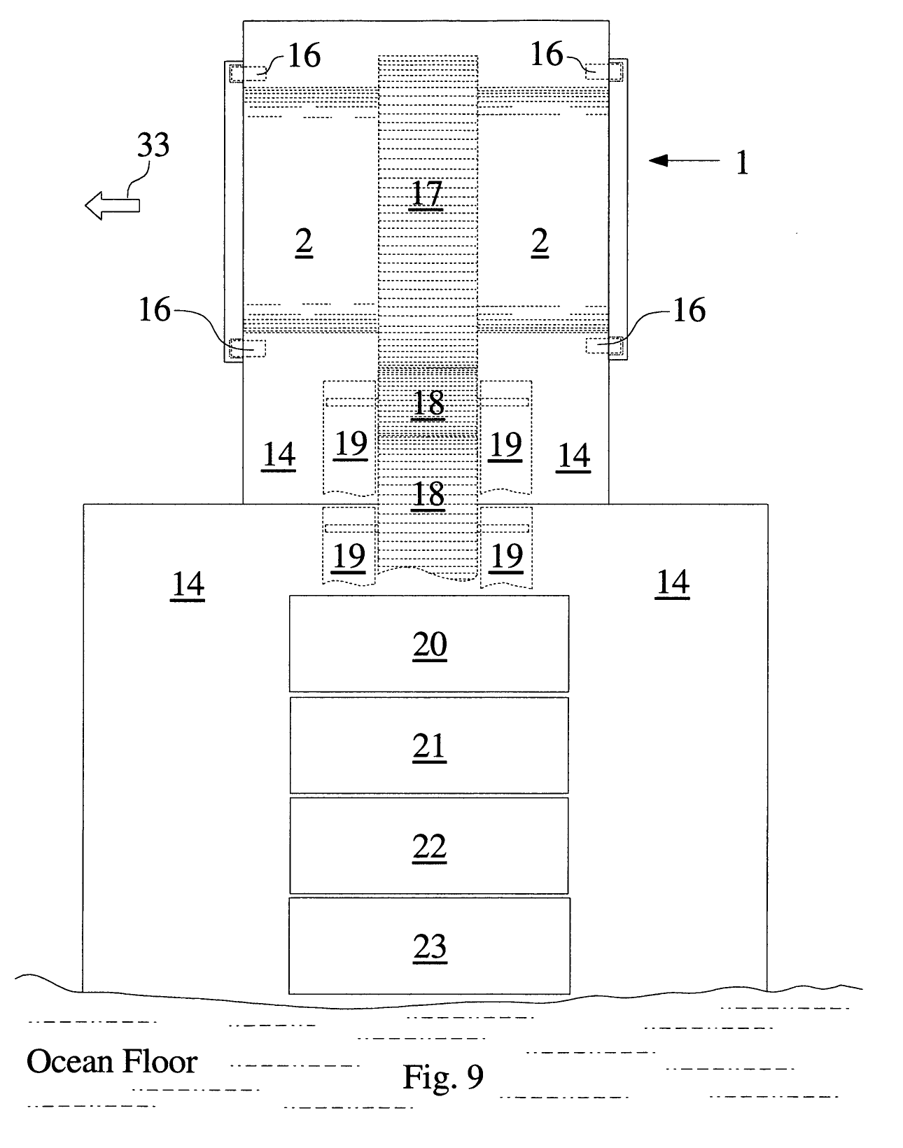

Referring to FIG. 9, contained within the submersible structure 14, in addition to the turbine 1, is the apparatus necessary to perform the specific mission of the installation. Apparatus include, but are not limited to: electric generators 21, distillation apparatus 22 and the equipment necessary for hydrogen production, for example electrolyzers 23. Debris from distillation and electrolysis may be collected and filtered for mineral content.

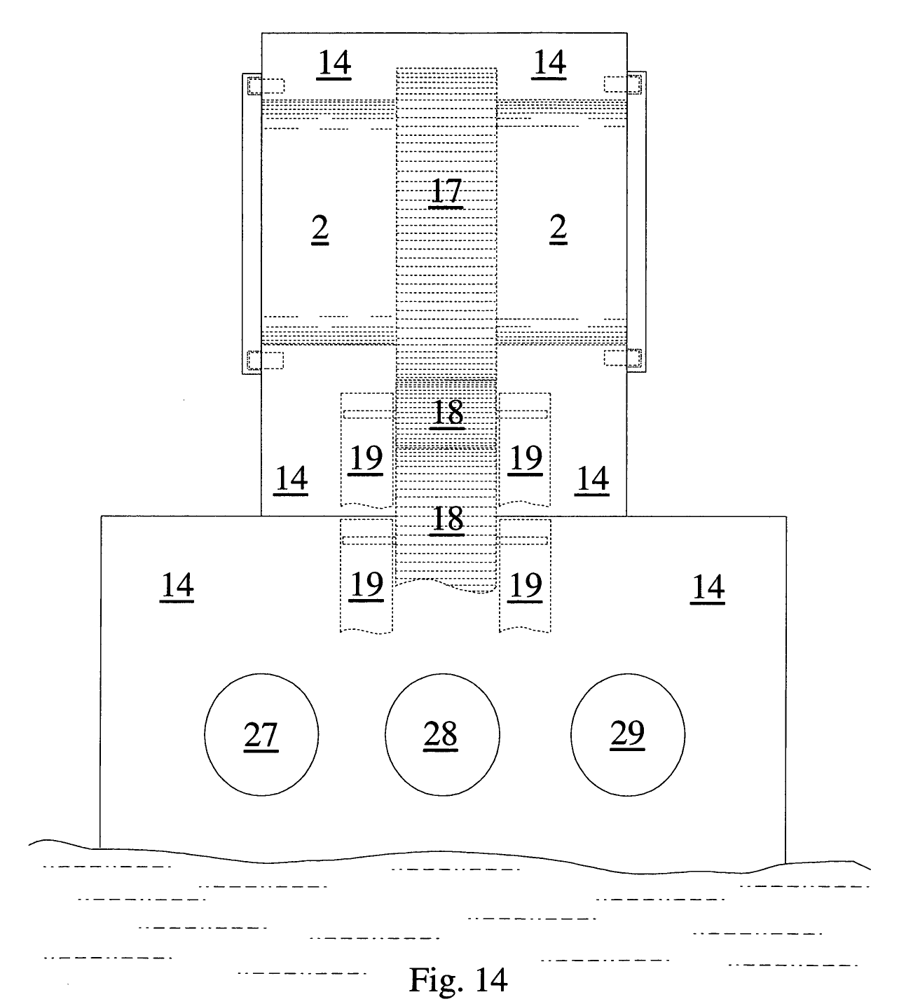

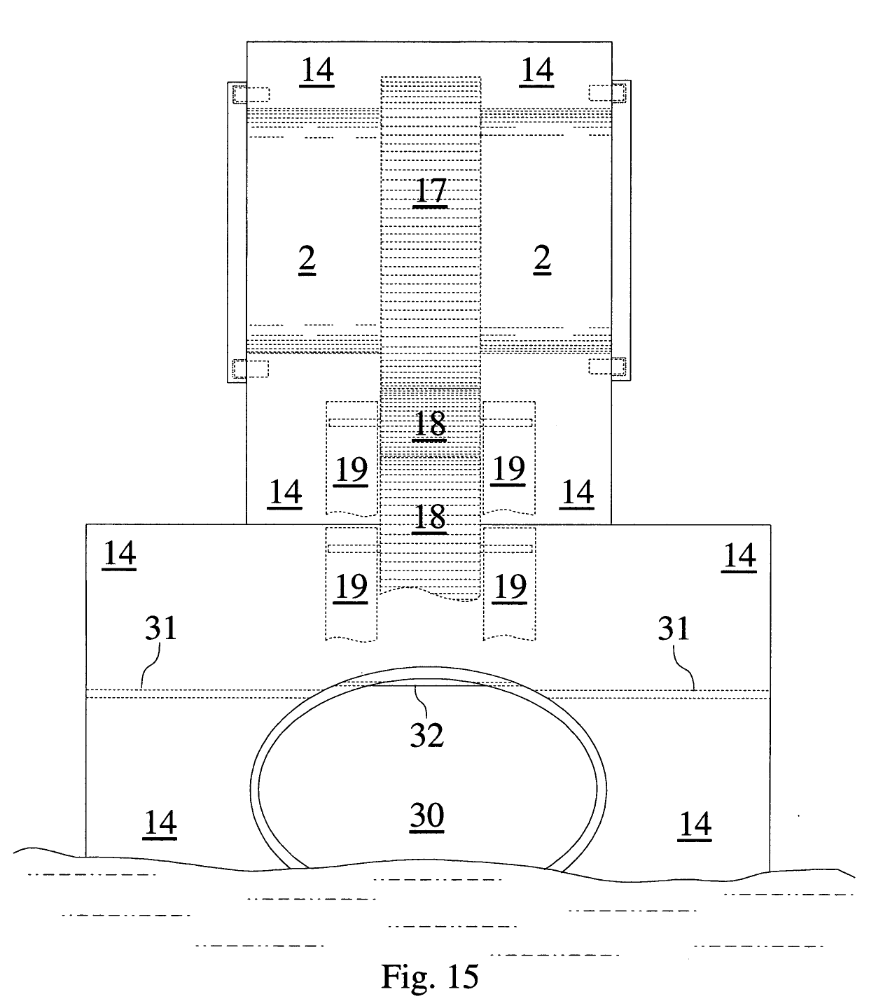

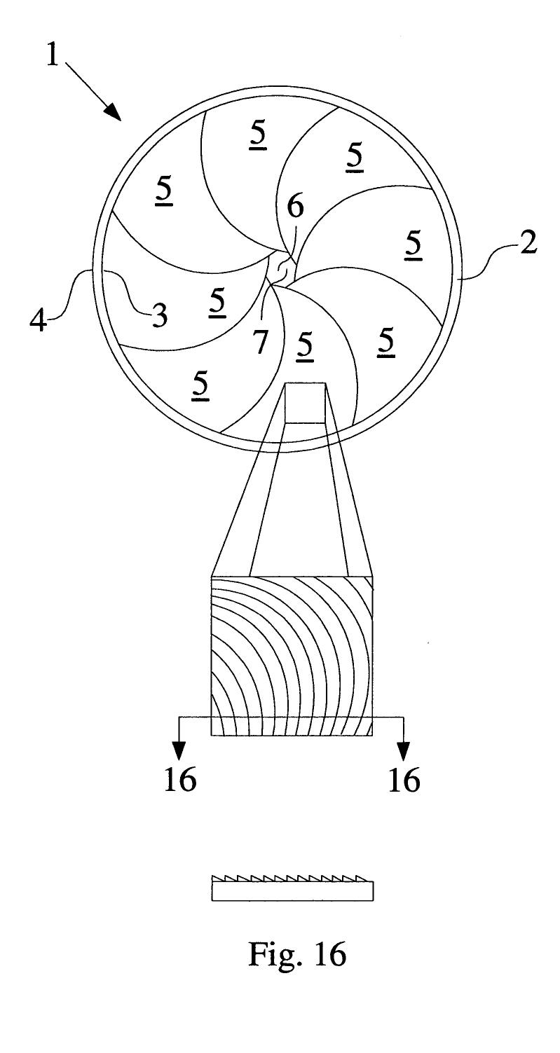

As shown in FIG. 14, underwater pipelines 27, 28, 29 carry the finished goods: electricity 29, hydrogen 27 and desalinated water 28 to their onshore destination. Moorings, above the site, provide a means for tankers to fill containers for export. Facilities shall be provided for the transfer of personnel and equipment 30, 32, as illustrated in FIG. 15.

The above description best describes a turbine implemented for capturing the kinetic energy found in the ocean currents. Minor changes to the above implementation, primarily blade design, will allow for bi-directional support to enhance efficiency in tidal applications.

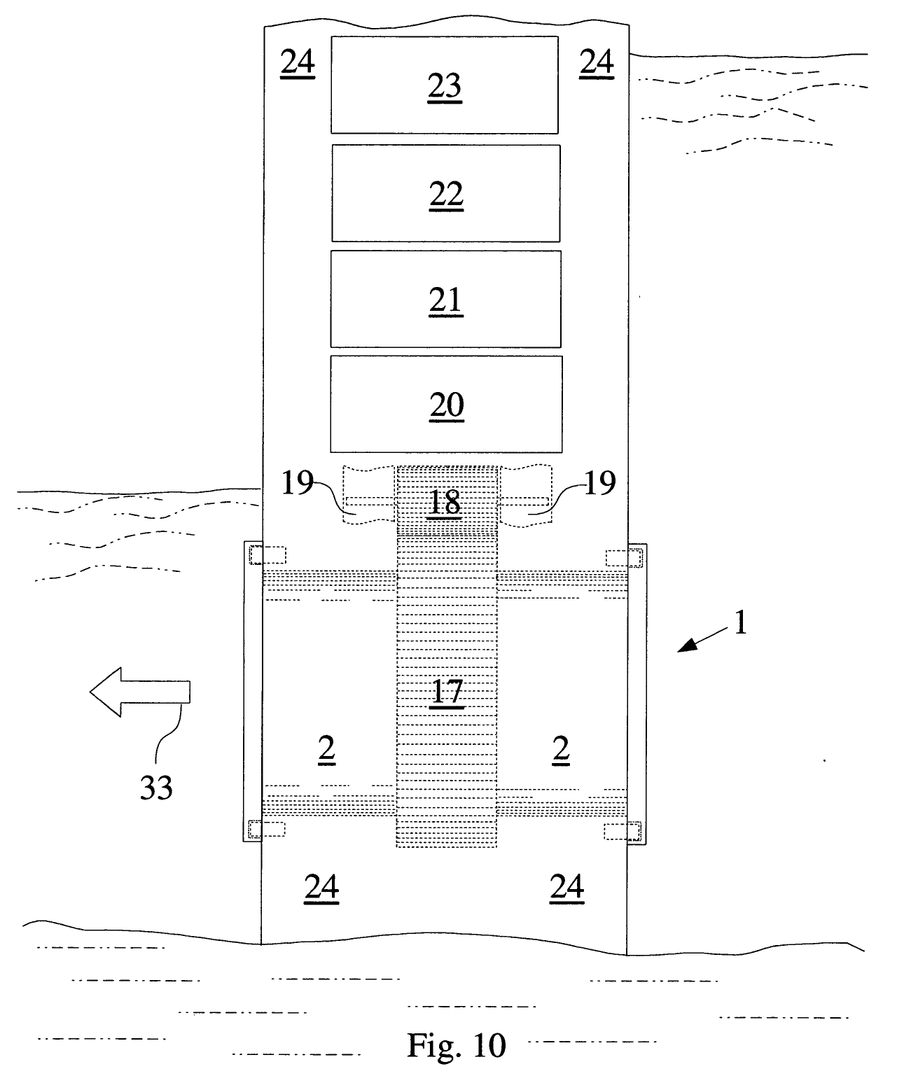

Referring to FIG. 10, the turbine 1 may also be used as a replacement for the Francis and Kaplan turbines used to generate power in hydroelectric power stations, typically located adjacent to a river 24.

The turbine 1 may also be used as a means of capturing kinetic energy found in exhaust systems, for example the exhaust systems of steam generators and steam engines.

Referring to FIG. 7, the support structure 14 is built of reinforced concrete onshore and towed into place by tugboats. The turbine 1 and supporting apparatus may be installed prior to placement of the support structure 14.

Referring to FIGS. 3, 7, 9, and 14, the hollow turbine 1 captures kinetic energy from entering ocean water 8 and transforms that energy into mechanical energy that ultimately turns generators 21 which provide electricity for the production of hydrogen 23 and purified water 22. Hydrogen is produced mainly for export 27. Excess electricity 29 and purified water 28 may also be exported for other purposes.

The ability to harness virtually unlimited amounts of kinetic energy will enable apparatus such as electric generators to operate effectively; with only interruptions for servicing, providing unlimited, environmentally friendly electric energy. Additional applications include desalination of seawater and hydrogen extraction from the aforementioned desalinated seawater and electricity produced and optionally imported from the national electric power grid.

Although a variety of embodiments have been particularly described, it should be understood that the above description is of preferred exemplary embodiments of the present invention, and that the invention is not limited to the specific forms described.

1. A turbine comprising:
a cylindrical shell having an inner and an outer surface, and a hole at each of the opposing ends of said cylindrical shell;
at least one plurality of blades attached to said inner surface of said cylindrical shell;
a supporting structure;
at least one means to allow said cylindrical structure to rotate freely in said supporting structure;
at least one rotational energy connecting element.

2. The turbine as claimed in claim 1, wherein said turbine is a hydraulic turbine.

3. The turbine as claimed in claim 1, wherein said turbine is a pneumatic turbine.

4. The turbine as claimed in claim 1, further comprising an axis.

5. The turbine as claimed in claim 1, wherein said plurality of blades are radially symmetrical to the said axis.

6. The turbine as claimed in claim 1, wherein the distal edges of said plurality of blades form a vacant hole whose center is said axis.

7. The turbine as claimed in claim 1, wherein the distal edges of said plurality of blades form a virtual point whose center is said axis.

8. The turbine as claimed in claim 1, wherein said plurality of blades allows for bidirectional energy capture.

9. The turbine as claimed in claim 1, wherein said means of rotation is a bearing.

10. The bearing as claimed in claim 9, wherein said bearing is a tapered roller bearing.

11. The tapered roller bearing as claimed in claim 10, wherein said tapered roller bearing is made from ceramic.

12. The bearing as claimed in claim 9, wherein said bearing is, in combination: a thrust bearing and a cylindrical roller bearing.

13. The bearing as claimed in claim 9, wherein said bearing is a hydrostatic bearing.

14. The bearing as claimed in claim 9, wherein said bearing is a magnetic bearing.

15. The turbine as claimed in claim 1, wherein said cylindrical shell is fabricated from composite materials.

16. The composite materials as claimed in claim 15, further comprising a titanium steel veneer.

17. The composite materials as claimed in claim 15, further comprising a stainless steel veneer.

18. The turbine as claimed in claim 1, where in said cylindrical shell further comprising a buoyancy means;
whereby said cylindrical shell is buoyantly neutral;
whereby the weight and drag associated with the affect of gravity on the said turbine is partially or fully negated.

19. The buoyancy means as claimed in claim 18, further comprising at least one vacant cavity within the body of said cylindrical shell.

20. The buoyancy means as claimed in claim 18, further comprising at least one means of filling and discharging said vacant cavity with ballast.

21. The filling and discharging means as claimed in claim 20, wherein said filling and discharging means is a valve.

22. The valve as claimed in claim 21, wherein said valve is a mechanical valve.

23. The valve as claimed in claim 21, wherein said valve is a servo valve.

24. The turbine as claimed in claim 1, where in said cylindrical shell further comprising an aeration means.

25. The turbine as claimed in claim 1, wherein said plurality of blades is fabricated from composite materials.

26. The composite materials as claimed in claim 25, further comprising a titanium steel veneer.

27. The composite materials as claimed in claim 25, further comprising a stainless steel veneer.

28. The turbine as claimed in claim 1, wherein the outer surface of said plurality of blades is irregular, wherein producing a riffling effect, whereby increasing the efficiency of said plurality of blades.

29. The turbine as claimed in claim 1, wherein said plurality of blades further comprising a buoyancy means.

30. The buoyancy means as claimed in claim 29, further comprising at least one vacant cavity within the body of each said blade in said plurality blades.
whereby said plurality of blades is buoyantly neutral;
whereby the weight and drag associated with the affect of gravity on the said turbine is partially or fully negated.

31. The turbine as claimed in claim 1, wherein said plurality of blades further comprising an aeration means.

32. The turbine as claimed in claim 1, wherein said rotational energy connecting element is a gear.

33. The turbine as claimed in claim 1, wherein said rotational energy connecting element is a belt with teeth.

34. The turbine as claimed in claim 1, wherein said rotational energy connecting element connects to a rotary transmission means.

35. The rotary transmission means as claimed in claim 34, wherein said rotary transmission means is a gear box.

36. The turbine as claimed in claim 1, wherein said supporting structure further comprising:
at least one means of rotation to mate with at least one said means of rotation as claimed in claim 1 to allow at least one said turbine to rotate freely;
an outer housing;
whereby facilities are provided for the operation of said turbine and enough room for the apparatus necessary for electricity generation, water purification and hydrogen production.

37. The means of rotation as claimed in claim 36, wherein said means of rotation is a bearing means.

38. The bearing means as claimed in claim 37, wherein said bearing means is a tapered roller bearing.

39. The tapered roller bearing as claimed in claim 38, wherein said tapered roller bearing is made from ceramic.

40. The bearing means as claimed in claim 37, wherein said bearing is in combination: a thrust bearing and a cylindrical roller bearing.

41. The bearing means as claimed in claim 37, wherein said bearing means is a hydrostatic bearing.

42. The bearing means as claimed in claim 37, wherein said bearing is a magnetic bearing.

43. The turbine as claimed in claim 1, wherein said supporting structure further comprising a means to elevate and lower said turbine.

44. The means to elevate and lower said turbine as claimed in claim 43, wherein said means is hydraulic.

45. The turbine as claimed in claim 1, wherein said supporting structure further comprising a means to rotate, with flows, said turbine.

46. The means to rotate said turbine as claimed in claim 45, wherein said means is hydraulic.

47. The supporting structure as claimed in claim 36, wherein said outer housing is made from concrete.

48. The supporting structure as claimed in claim 36, wherein said outer housing further comprising a foundation.

49. The supporting structure as claimed in claim 36, wherein said outer housing is submersible.

50. The supporting structure as claimed in claim 36, wherein said outer housing further comprising a means of exporting said hydrogen.

51. The means of exporting hydrogen as claimed in claim 50, wherein said export means is a pipeline connected to an onshore distribution means.

52. The means of exporting hydrogen as claimed in claim 50, wherein said export means is a pipeline connected to moorings where vessels may load said hydrogen.

53. The supporting structure as claimed in claim 36, wherein said outer housing further comprising a means of exporting said purified water.

54. The means of exporting purified water as claimed in claim 53, wherein said export means is a pipeline connected to an onshore distribution means.

55. The means of exporting purified water as claimed in claim 53, wherein said export means is a pipeline connected to moorings where vessels may load said purified water.

56. The supporting structure as claimed in claim 36, wherein said outer housing further comprising a means of exporting said electricity.

57. The means of exporting electricity as claimed in claim 56, wherein said export means is a super conductor inside a pipeline connected to an onshore distribution means.

58. The supporting structure as claimed in claim 36, wherein said outer housing is a dam;
whereby replacing the Francis and Kaplan turbines used in hydroelectric power plants.

59. The supporting structure as claimed in claim 36, wherein said outer housing is a breakwater.

60. The supporting structure as claimed in claim 36, wherein said outer housing is a harbor wall.

61. The supporting structure as claimed in claim 36, wherein said outer housing is an oil derrick.

62. The supporting structure as claimed in claim 36, wherein said outer housing is a exhaust system.

63. The exhaust system as claimed in claim 62, wherein said exhaust system is a component of a steam engine.

64. The exhaust system as claimed in claim 62, wherein said exhaust system is a component of a steam generator.

65. The turbine as claimed in claim 1, wherein said supporting structure further comprising a means to deflect debris and fish too large to safely pass through said turbine.

66. The deflection means as claimed in claim 65, wherein said deflection means is a grate.

67. The grate as claimed in claim 66, wherein said grate is fabricated from composite materials.

68. The composite materials as claimed in claim 67, further comprising a titanium steel veneer.

69. The composite materials as claimed in claim 67, further comprising a stainless steel veneer.

70. The turbine as claimed in claim 1, further comprising a funnel.

71. A turbine comprising:
a cylindrical shell having an inner and an outer surface, and a hole at each of the opposing ends of said cylindrical shell, wherein said cylindrical shell further comprises at least one plurality of blades attached to said inner surface of said cylindrical shell, and at least one rotational energy connecting element;
a means of housing said cylindrical structure and related apparatus, wherein said housing means further comprises at least one means to allow said cylindrical shell to rotate freely in said housing means, wherein flow of a fluid or gas over said plurality of blades causes said plurality of blades and said cylindrical shell to rotate.

72. A turbine comprising:
a cylindrical shell having an inner and an outer surface, and a hole at each of the opposing ends of said cylindrical shell, wherein said cylindrical shell further comprises at least one rotational energy connecting element;
at least one plurality of blades attached to said inner surface of said cylindrical shell
a means of housing said cylindrical structure and related apparatus, wherein said supporting structure further comprises at least one means to allow said cylindrical shell to rotate freely in said supporting structure, wherein flow of a fluid or gas over said plurality of blades causes said plurality of blades and said cylindrical shell to rotate.

73. A funnel comprising;
a funnel like structure;
at least one rib, wherein said rib channels the flow of passing fluids and gases in a direction perpendicular to the surface of a turbine's blades;
whereby the efficiency of any turbine is enhanced.

74. The funnel as claimed in claim 73, wherein said funnel like structure is comprised of a hollow cylinder with two vacant holes at opposing ends. One said vacant hole has a larger diameter than the other.

75. The funnel as claimed in claim 73, wherein said funnel-like structure is fabricated from composite materials.

76. The composite materials as claimed in claim 75, further comprising a titanium steel veneer.

77. The composite materials as claimed in claim 75, further comprising a stainless steel veneer.

78. A method for increasing the pressure applied to a turbine's blades by passing fluids and gases comprising:
providing a funnel;
providing at least one rib to channel passing fluids and gases in a direction perpendicular to said turbine blades;
whereby the efficiency of any turbine is greatly enhanced.

79. An electric power plant comprising:
a submersible housing;
at least one turbine comprising:
a cylindrical shell having an inner and an outer surface, and a hole at each of the opposing ends of said cylindrical shell;
at least one plurality of blades attached to said inner surface of said cylindrical shell;
at least one means to allow said cylindrical structure to rotate freely in a supporting structure;
at least one rotational energy connecting element;
a means of generating electricity;
whereby affordable, environmentally friendly electricity is safely produced.

80. The electric power plant as claimed in claim 79, wherein said means of generating electricity is an electric generator;

81. The electric power plant as claimed in claim 79, wherein said means of generating electricity is geothermal.

82. The electric power plant as claimed in claim 79, wherein said means of generating electricity is in combination: is said electric generator and said geothermal means.

83. The electric power plant as claimed in claim 79, wherein said means of generating electricity is a Hydroelectric Turbine For Producing Electricity From A Water Current: Williams; U.S. Pat. No. 6,648,589 B2; Nov. 18, 2003.

84. The electric power plant as claimed in claim 79, wherein said means of generating electricity is a Hydroelectric Powerplant: Williams; U.S. Pat. No. RE 38,336 E; Dec. 2, 2003.

85. The electric power plant as claimed in claim 79, wherein said means of generating electricity is a Hydroelectric Powerplant: Williams; U.S. U.S. Pat. No. 5,592,816; Jan. 14, 1997.

86. A method for producing electricity comprising:
capturing kinetic energy by means of turbine, and
transferring rotational energy from said turbine captured at the outermost surface of the said turbine, and
generating electrical energy from said rotational energy.

87. A water purification plant comprising;
a factory;
a means of acquiring electric power;
a means of providing ocean water;
a means of distilling said ocean water.

88. The water purification plant as claimed in claim 87, wherein said factory is a submersible structure.

89. The water purification plant as claimed in claim 87, wherein said factory is at least one onshore structure.

90. The distillation means as claimed in claim 87, wherein the distillation process mode is continuous.

91. The distillation means as claimed in claim 87, wherein the distillation process mode is batch.

92. The distillation means as claimed in claim 87, wherein the distillation condensation chamber is external to said submersible structure whereby said condensation chamber may benefit from the cooler temperatures of the surrounding ocean water or river water.

93. The water purification plant as claimed in claim 87, wherein said distillation means further comprising filtration.

94. The water purification plant as claimed in claim 87, wherein said means of acquiring electric power is an electric power plant comprising:
a submersible housing;
at least one turbine comprising:
a cylindrical shell having an inner and an outer surface, and a hole at each of the opposing ends of said cylindrical shell;
at least one plurality of blades attached to said inner surface of said cylindrical shell;
at least one means to allow said cylindrical structure to rotate freely in a supporting structure;
at least one rotational energy connecting element;
a means of generating electricity.

95. The water purification plant as claimed in claim 87, wherein said means of acquiring electric power is the national electric power grid.

96. The water purification plant as claimed in claim 87, wherein said means of acquiring electric power is in combination: said electric power plant and said national electric power grid.

97. The water purification plant as claimed in claim 87, wherein said means of acquiring electric power is a Hydroelectric Powerplant: Williams; U.S. Pat. No. 6,729,840 B2; May 4, 2004.

98. The water purification plant as claimed in claim 87, wherein said means of acquiring electric power is in combination: said Powerplant by Williams, U.S. Pat. No. 6,729,840 B2, and said national electric power grid.

99. The water purification plant as claimed in claim 87, wherein said means of acquiring electric power further comprises geothermal means.

100. A method for producing purified water comprising:
providing at least one source of electricity;
distilling ocean water from from said electrical energy.

101. A hydrogen production plant comprising;
a factory;
a means of acquiring electric power;
a means of ocean water purification;
a means of producing hydrogen;
whereby hydrogen is produced in an environmentally friendly manner and from an abundant source;
whereby oxygen is produced in an environmentally friendly manner and available for life support in submerged structures.

102. The hydrogen production plant as claimed in claim 101, wherein said factory is a submersible structure.

103. The hydrogen production plant as claimed in claim 101, wherein said factory is at least one onshore structure.

104. The hydrogen production plant as claimed in claim 101, wherein said means of producing hydrogen is an electrolyzer.

105. The electrolyzer as claimed in claim 104, wherein said electrolyzer produces oxygen, wherein submerged structures will be able to support life.

106. The hydrogen production plant as claimed in claim 101, wherein said means of ocean water purification is distillation.

107. The hydrogen production plant as claimed in claim 101, wherein said means of ocean water purification is filtration.

108. The hydrogen production plant as claimed in claim 101, wherein said means of ocean water purification is distillation and filtration.

109. The hydrogen production plant as claimed in claim 101, wherein said means of acquiring electric power is an electric power plant comprising:
a submersible housing;
at least one turbine comprising:
a cylindrical shell having an inner and an outer surface, and a hole at each of the opposing ends of said cylindrical shell;
at least one plurality of blades attached to said inner surface of said cylindrical shell;
at least one means to allow said cylindrical structure to rotate freely in a supporting structure;
at least one rotational energy connecting element;
a means of generating electricity.

110. The hydrogen production plant as claimed in claim 101, wherein said means of acquiring electric power is the national electric power grid.

111. The hydrogen production plant as claimed in claim 101, wherein said means of acquiring electric power is in combination said electric power plant and said national electric power grid.

112. The hydrogen production plant as claimed in claim 101, wherein said means of acquiring electric power is a Hydroelectric Powerplant: Williams; U.S. Pat. No. 6,729,840 B2; May 4, 2004.

113. The hydrogen production plant as claimed in claim 101, wherein said means of acquiring electric power is in combination said Hydroelectric Powerplant: Williams; U.S. Pat. No. 6,729,840 B2 and said national electric power grid.

114. The hydrogen production plant as claimed in claim 101, wherein said means of acquiring electric power further comprises geothermal means.

115. A method for producing hydrogen comprising:
providing at least one source of electrical energy;
distilling ocean water from from said electrical energy;
producing hydrogen and oxygen by electrolyzing said desalinated water from said electrical energy;
whereby providing an environmentally sound solution to hydrogen production.

116. A method for producing hydrogen comprising;
providing at least one source of electrical energy;
providing at least one source of desalinated water;
providing at least one method of producing hydrogen.

117. A method for producing rotational energy from the kinetic energy found in liquids and gases in motion comprising the steps of:
affixing at least one plurality of blades to the inner surface within a cylindrical shell, in a radially symmetrical manner, relative to the axis of rotation;
capturing said kinetic energy from said fluids and gases in motion by impeding the flow of said fluids and gases with the said plurality of blades. The resulting pressure rotates said cylindrical shell;
transferring said rotational energy from the outer surface of said cylindrical shell by means of a rotational energy connecting element;
whereby entering fish and debris safely exit through an opening formed by the distal edges of said plurality of blades referred to in the attached drawing as, “debris exhaust hole” and over the blades themselves.

118. A method for increasing the efficiency of a turbine's blades comprising:
providing an irregular surface on said turbine blade to increase the friction between passing fluids and gases and said turbine blades;
whereby enhancing the said turbine's ability to capture kinetic energy.

119. An Offshore Resource Factory comprising:
at least one submersible housing;
at least one turbine;
at least one means of acquiring electricity;
a means of desalination;
a means of electrolysis of said desalinated water;
at least one means of transferring resources, equipment and personnel to and from said submersible housing;
whereby a new yet untaped source of energy and water may be taped in an environmentally friendly and economically viable manner.
